(19) United States
(12) Patent Application Publication
(10) Pub. No.: US 2006/0149419 A1
(43) Pub. Date: Jul. 6, 2006

(54) Movable robot without falling over

(75) Inventors: Hideki Ogawa, Kanagawa (JP); Hideichi Nakamoto, Kanagawa (JP); Takafumi Sonoura, Tokyo (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/289,641

(22) Filed: Nov. 30, 2005

(30) Foreign Application Priority Data
Nov. 30, 2004 (JP) 2004-347419

(51) Int. Cl. G06F 19/00

(52) U.S. Cl. 700/245

(57) ABSTRACT

A movable robot includes a movement mechanism unit configured to perform driving for moving the movable robot; a body unit continuously connected to the movement mechanism unit in a movable manner in a planar direction between the movement mechanism unit and the body unit; and a shock absorber interposed between the movement mechanism unit and the body unit, for absorbing one of an inertial force and an external force generated by a movement control in the planar direction.

### CROSS-REFERENCE TO RELATED APPLICATIONS

This application is based upon and claims the benefit of priority from the prior Japanese Patent Application No. 2004-347419, filed on Nov. 30, 2004; the entire contents of which are incorporated herein by reference.

### BACKGROUND OF THE INVENTION

1. Field of the Invention

The present invention relates to the technique of a movable robot and, more particularly, to the technique for preventing any falling over caused by an inertial force or an external force generated when movement is controlled.

2. Description of the Related Art

There have been recently disclosed various kinds of robots which share an activity space with a person. There have been proposed numerous robots which are as tall as a person when a robot shares an activity space with the person. In this case, the robot may possibly fall over if the center of gravity is located at a high position.

In view of this, the technique for preventing any falling over has been devised such that the center of gravity is descended by loading equipment and materials in a skirt-like lower portion of a robot, as disclosed in, for example, Naoto Kawauchi et al., “Home Use Robot ‘wakamaru’”, Mitsubishi heavy industries technical review, Mitsubishi heavy industries, ltd., Vol. 40, No. 5, pp. 270-273, September, 2003 (hereinafter, “Naoto Kawauchi et al.”).

However, the technique disclosed in Naoto Kawauchi et al. has limited movement when a robot shares an activity space with a person caused by the wide lower portion of the robot. If the lower portion of the robot is constituted in an appropriate width accordingly, the center of gravity has been located at a high position, thereby raising a problem that the robot accidentally falls over at the time of abrupt start or abrupt stoppage.

### SUMMARY OF THE INVENTION

According to one aspect of the present invention, a movable robot includes a movement mechanism unit configured to perform driving for moving the movable robot; a body unit continuously connected to the movement mechanism unit in a movable manner in a planar direction between the movement mechanism unit and the body unit; and a shock absorber interposed between the movement mechanism unit and the body unit, for absorbing one of an inertial force and an external force generated by a movement control in the planar direction.

According to another aspect of the present invention, a movable robot includes a movement mechanism unit configured to perform driving for moving a movable robot; a body unit continuously connected to the movement mechanism unit via a pivot shaft on a plane between the movement mechanism unit and the body unit; and a shock absorber interposed between the movement mechanism unit and the body unit, for absorbing one of an inertial force and an external force generated by a movement control in swing directions by the pivot shaft.

### BRIEF DESCRIPTION OF THE DRAWINGS

FIG. 1 is a perspective view showing a structure of a movable robot, as viewed sideways, in a first embodiment;

FIG. 2 is a perspective view showing a structure of a continuously connecting portion between a body unit and a movement mechanism unit in the movable robot, as viewed from the top, in the first embodiment;

FIG. 3 is a view explanatory of the state of the continuously connecting portion between the body unit and the movement mechanism unit when the movable robot collides against an obstruction in front thereof during the movement of the movable robot in the first embodiment;

FIG. 4 is a block diagram showing functions of the movable robot in the first embodiment;

FIG. 5 is a table showing corresponding interrelations among states, positions, and controls when the movable robot in the first embodiment collides against the obstruction;

FIG. 6 is a flowchart showing processing procedures of the start of movement, the collision against the obstruction and the control of stoppage in the movable robot in the first embodiment;

FIG. 7 is a flowchart showing processing procedures of the collision against the obstruction and the control of the movement in a state in which the movable robot in the first embodiment is stopped;

FIG. 8 is a perspective view showing a structure of a continuously connecting portion between a body unit and a movement mechanism unit in a movable robot, as viewed sideways, in a second embodiment;

FIG. 9 is a perspective view showing a structure of the continuously connecting portion between the body unit and the movement mechanism unit in the movable robot, as viewed from the top, in the second embodiment;

FIG. 10 is a view explanatory of a state in which a body base plate is moved when a shock is exerted sideways on the body unit in the movable robot in the second embodiment;

FIG. 11 is a perspective view showing a continuously connecting portion between a body unit and a movement mechanism unit in a movable robot, as viewed sideways, in a third embodiment;

FIG. 12 is a perspective view showing the continuously connecting portion between the body unit and the movement mechanism unit in the movable robot, as viewed from the front, in the third embodiment;

FIG. 13 is a view showing an external appearance of a swing quantity detector;

FIG. 14 is a perspective view showing a continuously connecting portion between a body unit and a movement mechanism unit in a movable robot, as viewed sideways, in a fourth embodiment;

FIG. 15 is a perspective view showing the continuously connecting portion between the body unit and the movement mechanism unit in the movable robot, as viewed from the front, in the fourth embodiment;

FIG. 16 is a perspective view showing a structure of the continuously connecting portion between the body unit and the movement mechanism unit in the movable robot, as viewed from the top, in the fourth embodiment;

FIG. 17 is a general view showing a shape of an intermediate rotation support plate in the movable robot in the fourth embodiment;

FIG. 18 is a view showing the arrangement of wheels and an auxiliary wheel provided in a movable robot in a first modification; and

FIG. 19 is a view showing the arrangement of wheels provided in a movable robot in a second modification.

### DETAILED DESCRIPTION OF THE PREFERRED EMBODIMENTS

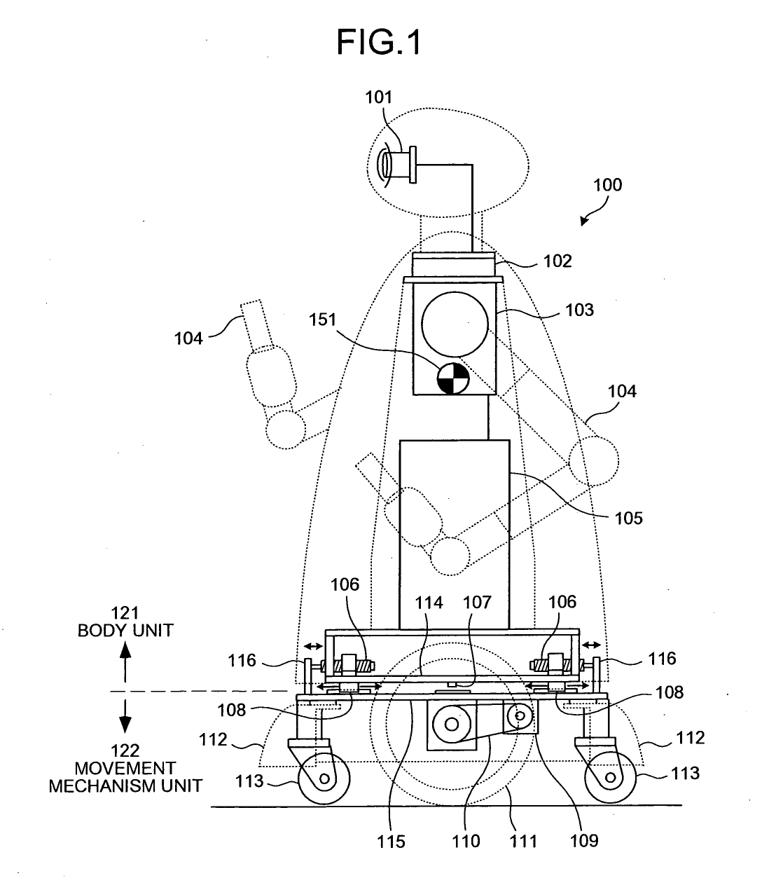

FIG. 1 is a perspective view showing a structure of a movable robot 100, as viewed sideways, in a first embodiment. As shown in FIG. 1, the movable robot 100 independently includes a body unit 121 and a movement mechanism unit 122, which are continuously connected to each other via linear guides 108. The body unit 121 is provided with constituent elements required for the movable robot 100 other than constituent elements required for a movement mechanism. Reference numeral 151 at an upper portion of the body unit 121 designates the position of the center of gravity of the movable robot 100. In contrast, the movement mechanism unit 122 is provided with constituent elements required for movement. Since the body unit 121 and the movement mechanism unit 122 are continuously connected to each other via the linear guides 108, the body unit 121 can be moved straight under the guidance of rails of the linear guides 108 independently of the movement mechanism unit 122.

The body unit 121 includes a visual module 101, a head controller 102, an arm controller 103, arms 104, a control unit 105, shock absorbers 106, a movement quantity detector 107 and a body base plate 114.

The visual module 101 is provided with a front camera. Data on an image picked up by the camera is input to the control unit 105. An object or a person, which exists at a movement destination, can be recognized by subjecting the input image data to a predetermined processing by the control unit 105, described later.

The head controller 102 controls rotational movement of a head. Thus, it is possible to vary a direction in which the visual module 101 picks up an image.

The arm controller 103 controls the driving of the arm 104, described later. The arm controller 103 controls the driving of the arm 104, thereby achieving the processing of holding an article by the arm 104. Furthermore, the arm controller 103 can control the driving for the purpose of the movement or keep balance by the use of the arm 104 if the movable robot 100 collides against an obstruction. For example, the arm controller 103 enables the arm 104 to extend in a movement direction in order to keep the balance in the case of abrupt stoppage.

The driving of the arm 104 is controlled by the arm controller 103, so that the arm 104 can execute a preset processing. Here, the preset processing includes, for example, the processing of holding an article by the arm 104.

The control unit 105 determines a situation based on signals received from the visual module 101 and the movement quantity detector 107, described later, and then, outputs a signal to the head controller 102, the arm controller 103 or a drive controller 109, described later, thus performing an appropriate control.

The shock absorber 106 is fixed to the body base plate 114, described later. Support plates 116 in the movement mechanism unit 122, described later, are supported by piston rods provided at the shock absorbers 106, so that the shock absorber 106 can absorb an inertial force or an external force generated between the body unit 121 and the movement mechanism unit 122. The shock absorber 106 in the first embodiment absorbs force in the straight direction in which the shock absorber 106 can be moved by the linear guide 108. The shock absorber 106 may be merely a member for absorbing the inertial force or the external force generated by a drive control. For example, the shock absorber 106 in the first embodiment is provided with a piston rod and incorporates an orifice structure inside thereof, so as to hydraulically absorb the force. Thus, the shock absorber 106 in the first embodiment can act as a resistance of the square of a speed.

In the first embodiment, the piston rod in the shock absorber 106 can be moved by 15 mm, and further, the piston rod is provided in a state in which the piston rod is retracted by 3 mm at the stoppage or without any exertion of the external force.

The movement quantity detector 107 is fixed to the body base plate 114, described later. The movement quantity detector 107 detects a movement quantity with respect to the movement mechanism unit 122 existing under the movement quantity detector 107 in the fixed state, and then, outputs it to the control unit 105. Consequently, the control unit 105 can recognize the movement quantity of the body unit 121 with respect to the movement mechanism unit 122. Moreover, in the first embodiment, the movement quantity detected by the movement quantity detector 107 includes only a movement quantity in the straight direction in which the linear guide 108 guides.

The body base plate 114 is a base plate for the body unit 121. A lower surface of the body base plate 114 is connected to the linear guides 108. The body base plate 114 can be moved in the straight direction in which the rail of the linear guide 108 guides. Additionally, the shock absorbers 106 are secured to an upper surface of the body base plate 114 while the movement quantity detector 107 is attached to the lower surface thereof.

In the meantime, the movement mechanism unit 122 is constituted of a movement mechanism base plate 115, the support plates 116, the drive controller 109, a drive belt 110, a wheel 111, a bumper 112 and auxiliary wheels 113.

The movement mechanism base plate 115 is a base plate for the movement mechanism unit 122, and is provided in parallel to a plane, on which the movable robot 100 is moved. To an upper surface of the movement mechanism base plate 115 are fixed the rails of the linear guides 108. The body base plate 114 is moved on the linear guides 108, so that the body unit 121 can be moved independently of the movement mechanism unit 122. Moreover, a measurement plate for use in detecting the movement quantity by the movement quantity detector 107 is disposed at the upper surface of the movement mechanism base plate 115.

Furthermore, since the movement mechanism base plate 115 is provided in parallel to the plane on which the movable robot 100 is moved, the body base plate 114 also is moved in parallel to the movement plane. As a consequence, the shock absorber 106 can absorb only the inertial force at the time of abrupt start or abrupt stoppage.

The support plates 116 are secured to the upper surface of the movement mechanism base plate 115, so as to support the piston rods of the shock absorbers 106 fixed to the body unit 121.

The drive controller 109 is provided with a mechanism required for the driving such as a motor, for controlling the driving required for the movement based on the signal received from the control unit 105. Moreover, the drive controller 109 can control the driving required for the abrupt start or the abrupt acceleration in accordance with the signal received from the control unit 105.

The drive belt 110 is a belt for use in transmitting the driving from the drive controller 109 to the wheel 111.

The wheel 111 is rotated upon the transmission of the driving by the drive belt 110. Thus, the movable robot 100 can be moved.

The bumper 112 is disposed in the direction in which the movable robot 100 is moved, and is adapted to absorb a shock if the movable robot 100 collides against an obstruction. Moreover, the bumper 112 is provided with a sensor, not shown, for detecting collision. The sensor outputs a signal indicating the collision to the control unit 105 at the time of the detection of the collision. When the control unit 105 receives the signal indicating the collision, it outputs a signal instructing stoppage to the drive controller 109. As a consequence, the movement mechanism unit 122 in the movable robot 100 can stop the movement in the case of the collision.

The auxiliary wheels 113 are secured to the lower surface of the movement mechanism base plate 115 in the movable robot 100, and are adapted to assist the upright posture of the movable robot 100 in contact with a movement plane. In the first embodiment, one auxiliary wheel 113 is disposed forward and rearward of the movable robot 100, respectively. Incidentally, the auxiliary wheel 113 may be arbitrarily disposed as long as the movable robot 100 can be stably kept in the upright posture.

In the movable robot 100 such configured as described above, the body unit 121 can be moved independently of the movement mechanism unit 122, and further, the shock absorbers 106 are disposed in the body unit 121 and the movement mechanism unit 122, thus absorbing the inertial force generated by the abrupt start or the abrupt acceleration.

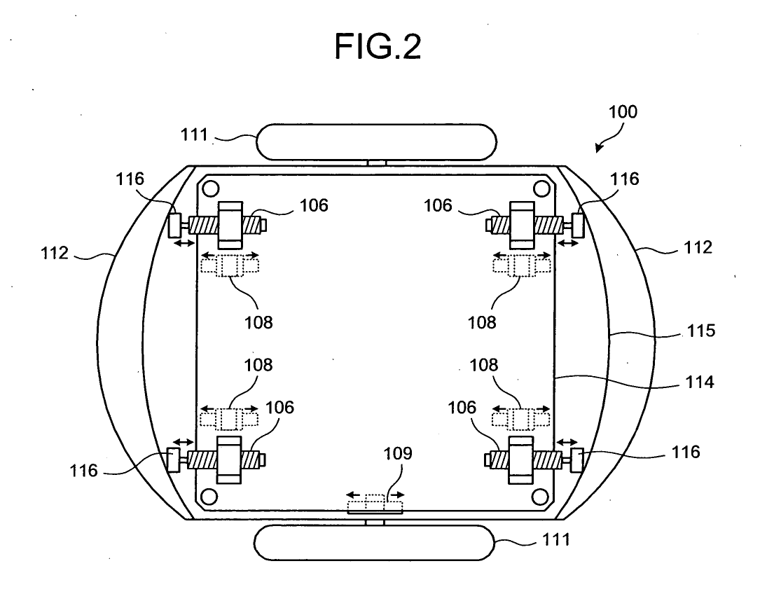

FIG. 2 is a perspective view showing a structure of a continuously connecting portion between the body unit 121 and the movement mechanism unit 122, as viewed from the top. As shown in FIG. 2, the four linear guides 108 and the four shock absorbers 106 are provided. Each of the linear guides 108 has a mechanism, which is moved in a direction indicated by a double-headed arrow along a rail, so that the body base plate 114 fixed at the lower surface thereof to the linear guides 108 also can be moved in the direction indicated by the arrow. When the body base plate 114 is moved, the piston rod of the shock absorber 106 fixed to the body base plate 114 is depressed down to the support plate 116, thereby exhibiting a shock absorbing function.

Additionally, since the movement quantity detector 107 also is secured to the lower surface of the body base plate 114, it is moved together with the body base plate 114. Consequently, the movement quantity detector 107 detects the movement quantity of the body unit 121 with respect to the movement mechanism unit 122.

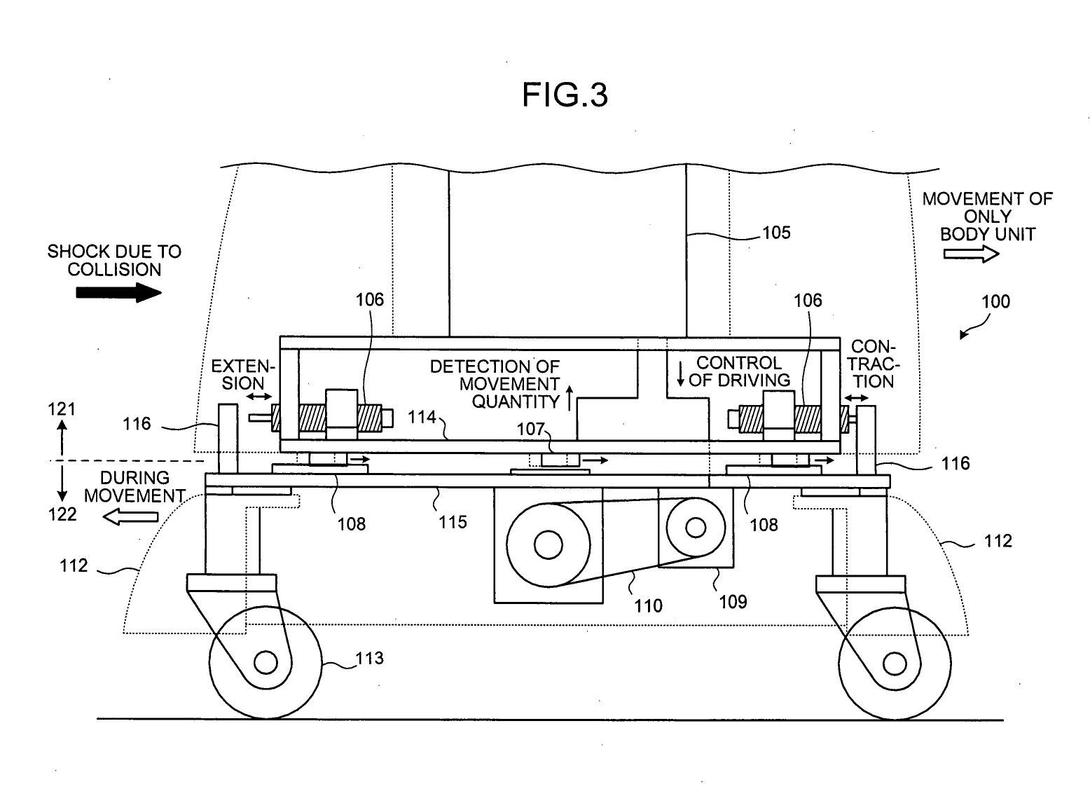

FIG. 3 is a view explanatory of the state of the continuously connecting portion between the body unit 121 and the movement mechanism unit 122 when the movable robot 100 collides against an obstruction in front thereof during the movement. As shown in FIG. 3, if the movable robot 100 collides against an obstruction existing in front of the movable robot 100 during the movement of the movable robot 100 in a direction indicated by an open arrow, a shock is exerted on the body unit 121 in a direction indicated by a solid arrow. With the exertion of the shock, the body unit 121 slides in the straight direction under the guidance of the rails of the linear guides 108. At this time, the piston rods of the shock absorbers 106 provided in the direction of the movement destination of the body unit 121 are depressed down by the support plates 116, thereby absorbing the shock. Moreover, the movement quantity detector 107 detects the movement quantity of the body unit 121 with respect to the movement mechanism unit 122, and then, outputs a signal to the control unit 105.

If the control unit 105 detects a movement quantity of a predetermined value or more, it determines that the movable robot 100 collides against the obstruction. In the first embodiment, the predetermined value is set at 5 mm. Therefore, if the control unit 105 detects a movement quantity of 5 mm or more during the movement, it determines that the movable robot 100 collides against the obstruction, and as a consequence, it outputs a signal instructing the control of the stoppage of the driving to the drive controller 109.

In this manner, when the external force such as the shock generated by the collision against the obstruction is exerted on the body unit 121, the body unit 121 slides, and then, the shock absorbers 106 absorb the external force, thereby preventing the movable robot 100 from falling over due to the collision. Furthermore, the independent slide of the body unit 121 can alleviate the shock caused by the collision. Additionally, if the movable robot 100 collides against the obstruction during the movement, the movement is stopped.

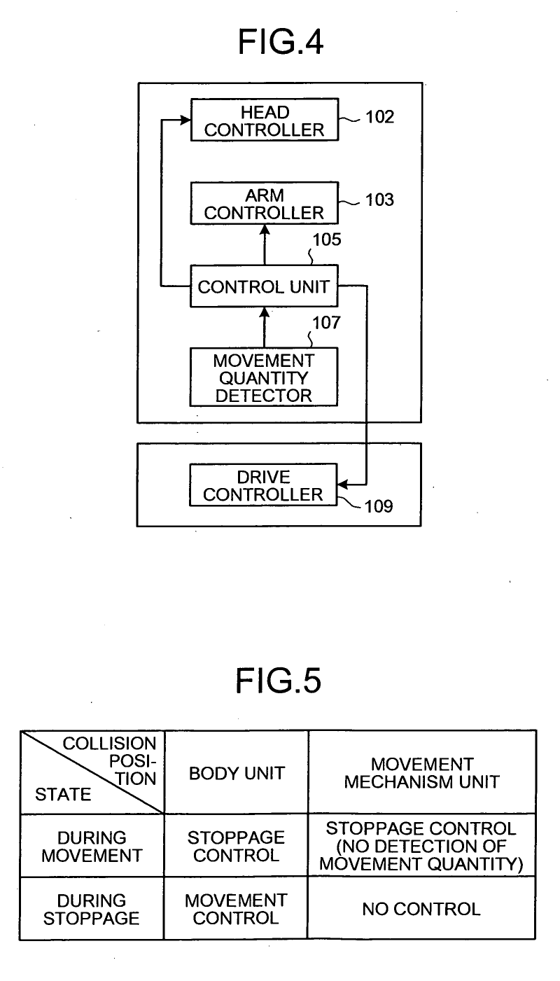

FIG. 4 is a block diagram showing functions of the movable robot 100 in the first embodiment. As shown in FIG. 4, the movable robot 100 includes the head controller 102, the arm controller 103, the control unit 105, the movement quantity detector 107 and the drive controller 109. In the case where the movement quantity detector 107 detects a movement quantity of 5 mm or more during the movement, it determines that the movable robot 100 collides against the obstruction, and as a consequence, the control is performed to stop the movement in an emergency.

As shown in FIG. 4, when the movement quantity detector 107 detects the movement quantity during the movement of the movable robot 100, the movement quantity detector 107 outputs a signal indicating the movement quantity to the control unit 105. Thereafter, the control unit 105 outputs a signal required for performing an appropriate control to prevent any falling over to the drive controller 109, the arm controller 103 or the head controller 102 if the received movement quantity is 5 mm or more.

Moreover, the control unit 105 outputs, to the drive controller 109, a signal instructing the control to stop the movement as the appropriate control to prevent any falling over. Otherwise, the control unit 105 may output, to the arm controller 103, a signal instructing the control to allow the arms 104 to extend for the purpose of keeping the balance. Alternatively, the control unit 105 may output, to the head controller 102, a signal instructing a rotation control to confirm the obstruction by the visual module 101.

In the meantime, the movement quantity detector 107 detects the movement quantity even in the case of the abrupt acceleration, the abrupt deceleration or the stoppage in an emergency, and then, outputs a signal to the control unit 105. In this way, there may be a possibility that the control unit 105 determines the collision against the obstruction. However, the control unit 105 outputs the signal instructing the control to the drive controller 109, so that the control unit 105 can discriminate between the movement quantity caused by the acceleration or deceleration and the movement quantity caused by a contact or the like.

Consequently, the stoppage control can be performed in response to the signal output from the control unit 105 in the case of the detection of a movement quantity of 5 mm or more caused by the contact or the like: in contrast, the control unit 105 cannot perform any specific control in the case of the detection of a movement quantity of 5 mm or more caused by the abrupt acceleration or the abrupt deceleration.

FIG. 5 is a table showing the corresponding interrelations among states, positions and controls when the movable robot 100 collides against the obstruction. As shown in FIG. 5, the control to be performed depends upon whether the collision position is the body unit 121 or the movement mechanism unit 122 or whether the movable robot 100 is being moved or stopped.

As shown in FIG. 5, when the body unit 121 collides against the obstruction during the movement of the movable robot 100, the control unit 105 outputs the signal instructing the stoppage control to the drive controller 109. To the contrary, when the body unit 121 collides against the obstruction during the stoppage of the movable robot 100, the control unit 105 outputs, to the drive controller 109, a signal instructing a drive control so as to move the movable robot 100 in the direction in which the body unit 121 slides upon the collision in order to prevent any falling over.

Further, when the obstruction collides against the movement mechanism unit 122 during the movement of the movable robot 100 and the sensor provided in the bumper 112 detects the collision, the sensor outputs a signal indicating the collision to the control unit 105. And then, when the control unit 105 receives the signal indicating the collision from the sensor, the control unit 105 outputs, to the drive controller 109, a signal instructing the stoppage control irrespective of the result of the movement quantity detected by the movement quantity detector 107.

To the contrary, when the obstruction collides against the movement mechanism unit 122 during the stoppage of the movable robot 100 and the sensor provided in the bumper 112 detects the collision, the sensor outputs the signal indicating the collision to the control unit 105. And then, even if the control unit 105 receives the signal indicating the collision, the control unit 105 does not especially perform any control since the movable robot 100 is stopped.

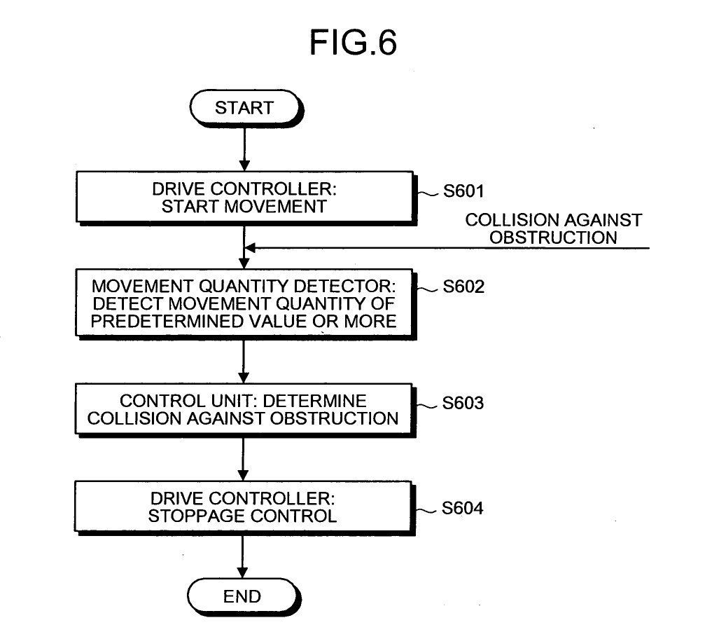

Next, explanation will be made below on the processing of the start of the movement, the collision against the obstruction and the stoppage control in the movable robot 100 such configured as described above in the first embodiment. FIG. 6 is a flowchart showing the above-described processing procedures in the movable robot 100 in the first embodiment.

First, the drive controller 109 performs the control to start the driving to start the movement in response to the signal output from the control unit 105 (step S601). And then, the body unit 121 in the movable robot 100 is assumed to collide with the obstruction.

Subsequently, upon the collision of the body unit 121 against the obstruction, the movement quantity detector 107 detects the movement quantity of the predetermined value, that is, 5 mm or more, and then, outputs the detected movement quantity to the control unit 105 (step S602).

The control unit 105 determines the collision against the obstruction when the received movement quantity is 5 mm or more, and then, outputs the signal instructing the stoppage control of the driving to the drive controller 109 (step S603). In contrast, the control unit 105 does not especially perform any control when the received movement quantity is less than 5 mm, and thus, the movable robot 100 is kept to be moved as it is.

Thereafter, the drive controller 109 performs the stoppage control of the driving when the drive controller 109 receives the signal from the control unit 105 (step S604).

In accordance with the above-described processing procedures, the stoppage control can be performed in the case of the collision of the obstruction against the body unit 121, thereby enhancing safeness.

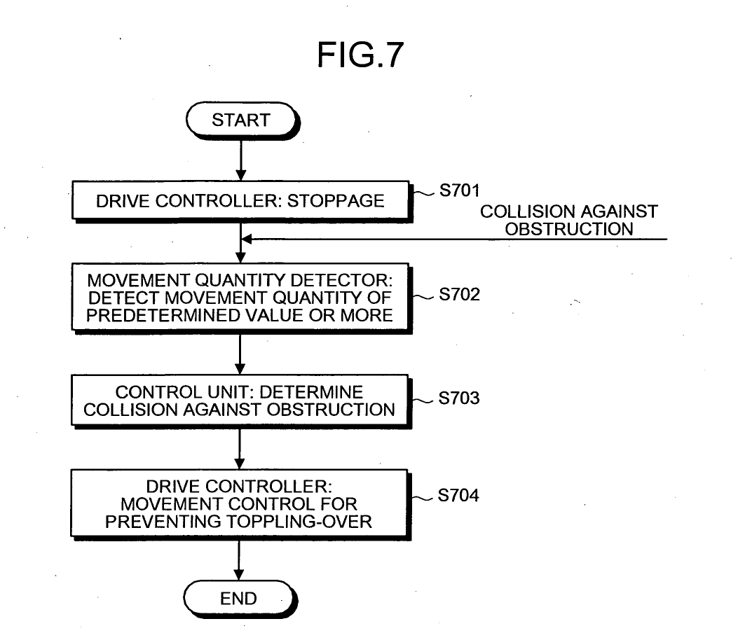

Next, explanation will be made below on the processing from the collision against the obstruction in the stoppage state up to the movement control in the movable robot 100 such configured as described above in the first embodiment. FIG. 7 is a flowchart showing the above-described processing procedures in the movable robot 100 in the first embodiment.

First, the movable robot 100 is kept to be stopped and the drive controller 109 does not especially perform any control as long as no signal is output from the control unit 105 (step S701). And then, the body unit 121 in the movable robot 100 is assumed to collide with the obstruction.

Subsequently, upon the collision of the body unit 121 against the obstruction, the movement quantity detector 107 detects the movement quantity of the predetermined value, that is, 5 mm or more, and then, outputs the detected movement quantity to the control unit 105 (step S702).

The control unit 105 determines the collision against the obstruction when the received movement quantity is 5 mm or more, and then, outputs the signal instructing the control of the driving to the drive controller 109 (step S703). In contrast, the control unit 105 does not especially perform any control when the received movement quantity is less than 5 mm, and thus, the movable robot 100 is kept to be moved as it is.

Thereafter, the drive controller 109 starts the control of the driving to move the movable robot 100 when the drive controller 109 receives the signal from the control unit 105 (step S704).

That is to say, if the external force more than a predetermined magnitude is exerted on the body unit 121 in the state in which the movable robot 100 is stopped, and further, the movable robot 100 is inclined at an angle greater than a predetermined value on the movement plane, the movable robot 100 accidentally falls over. However, the movable robot 100 is moved in the direction in which the external force is exerted in accordance with the above-described processing procedures, so that the movable robot 100 cannot be inclined at the predetermined angle or greater, to be thus prevented from falling over.

In the movable robot 100 in the first embodiment, the shock absorbers 106 need be not always housed inside of the body unit 121. For example, the shock absorbers may be attached to the lower surface of the movement mechanism base plate 115 in the movement mechanism unit 122, so as to absorb the inertial force or the external force between the shock absorbers and the support plates fixed to the body unit.

Although the movement quantity as a criterion for the judgment of the collision against the obstruction has been set at 5 mm in the first embodiment, the predetermined movement quantity is not limited to 5 mm. In actual, an optimum movement quantity is set in consideration of the maximum resistance of the shock absorber or the weight of the movable robot.

Otherwise, although the linear guides 108 have been used for continuously connecting the body unit 121 and the movement mechanism unit 122 to each other, any method may be used as long as the body unit 121 and the movement mechanism unit 122 are continuously connected to each other and the body unit 121 can be moved on the above-described plane with respect to the movement mechanism unit 122.

The movable robot 100 in the first embodiment can prevent any falling over by absorbing the inertial force generated by the abrupt start or the abrupt acceleration and the external force exerted on the body unit 121 even if the center of gravity is located at a high position.

Additionally, the body unit 121 in the movable robot 100 can slide independently of the movement mechanism unit 122, thereby alleviating the shock caused by the collision so as to enhance the safeness.

For example, when the movable robot 100 moves or works near a person, there is a possibility of an unexpected contact with the body unit 121 including the arms 104. The shock absorber 106 can absorb force generated by the collision even in the case of such a contact, thereby enhancing the safeness.

In addition, the movable robot 100 has been provided with the above-described mechanism, so that the falling over can be prevented even if the center of gravity is located at the high position. As a consequence, it has become unnecessary to take a great interval between the wheels in order to prevent any falling over. In other words, an area required for installing the movable robot 100 in the first embodiment is smaller. Thus, the movable robot 100 can be agilely moved, and at the same time, can be moved even at a narrow movement path.

The linear guides 108 have been disposed only in the direction, in which the movable robot 100 advances straight, in the movable robot 100 in the first embodiment. Therefore, the body unit 121 cannot slide when the movable robot 100 collides sideways with the obstruction, so that the shock cannot be absorbed. In view of this, perpendicular linear guides are provided in a movable robot in a second embodiment in place of the linear guides, and thus, a body unit can slide even when the movable robot collides sideways with an obstruction.

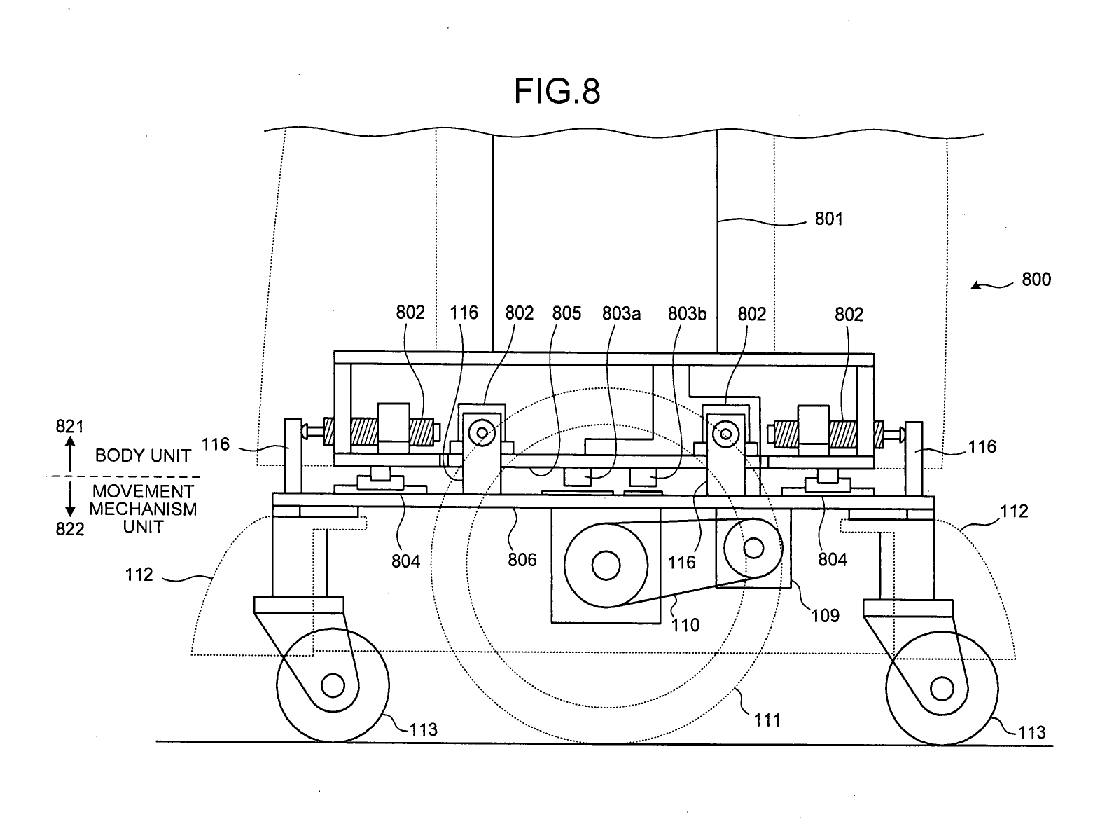

FIG. 8 is a perspective view showing a structure of a continuously connecting portion between a body unit 821 and a movement mechanism unit 822 in a movable robot 800, as viewed sideways, in the second embodiment. The same constituent elements as those in the first embodiment will be designated by the same reference numerals, and therefore, the description will be omitted below.

Since the body unit 821 and the movement mechanism unit 822 are continuously connected to each other via perpendicular linear guides 804, the body unit 821 can be moved on a plane, on which the body unit 821 is guided on rails of the perpendicular linear guides 804, independently of the movement mechanism unit 822. Incidentally, the detailed shape of the perpendicular linear guide 804 will be described later.

A control unit 801 is different from the control unit 105 in the first embodiment in that the control unit 801 determines a situation based on signals received from two movement quantity detectors 803a and 803b, which are different in detection direction from each other, and then, outputs a signal instructing an appropriate control to a head controller 102, an arm controller 103 or a drive controller 109, described later.

Shock absorbers 802 are fixed to a body base plate 805, described later. Support plates 116, described later, in the movement mechanism unit 822 are supported by piston rods provided at the shock absorbers 802, which thus absorb an inertial force or an external force generated between the body unit 821 and the movement mechanism unit 822. Here, the eight shock absorbers 802 in total are mounted on the body base plate 805. In the shock absorber 802, the tip of the piston rod is formed into a semispherical shape, thereby reducing friction between the support plate 116 and the piston rod. The shock absorber 802 is configured in the same manner as the shock absorber 106 in the first embodiment except for the shape of the tip of the piston rod.

The movement quantity detector 803a and the movement quantity detector 803b are fixed to the body base plate 805, described later. The movement quantity detector 803a detects a movement quantity in a direction, in which the movable robot 800 advances straight, with respect to the movement mechanism unit 822, and then, outputs a signal to the control unit 801. In contrast, the movement quantity detector 803b detects a movement quantity in a direction perpendicular to the direction detected by the movement quantity detector 803a with respect to the movement mechanism unit 822, and then, outputs a signal to the control unit 801.

The body base plate 805 is a base plate for the body unit 821. The body base plate 805 is connected at the lower surface thereof to the perpendicular linear guides 804. The body base plate 805 can be moved on the perpendicular linear guides 804, to be thus moved on a plane parallel to a movement mechanism base plate 806. Additionally, the shock absorbers 802 are secured to the upper surface of the body base plate 805 while the movement quantity detector 803a and the movement quantity detector 803b are attached to the lower surface thereof.

In the meantime, the movement mechanism unit 822 is different from the movement mechanism unit 122 in the first embodiment in that the movement mechanism base plate 115 is replaced with the movement mechanism base plate 806 having another constitution arranged at the upper surface thereof.

To the upper surface of the movement mechanism base plate 806 are fixed the rails of the perpendicular linear guides 804. Moreover, measurement plates for use in detecting the movement quantities by the movement quantity detector 803a and the movement quantity detector 803b are mounted at the upper surface of the movement mechanism base plate 806. Here, the eight support plates 116 in total are erected at the upper surface of the movement mechanism base plate 806.

In the movable robot 800 such configured as described above, the body unit 821 can be moved independently of the movement mechanism unit 822 on the plane parallel to the movement mechanism base plate 806.

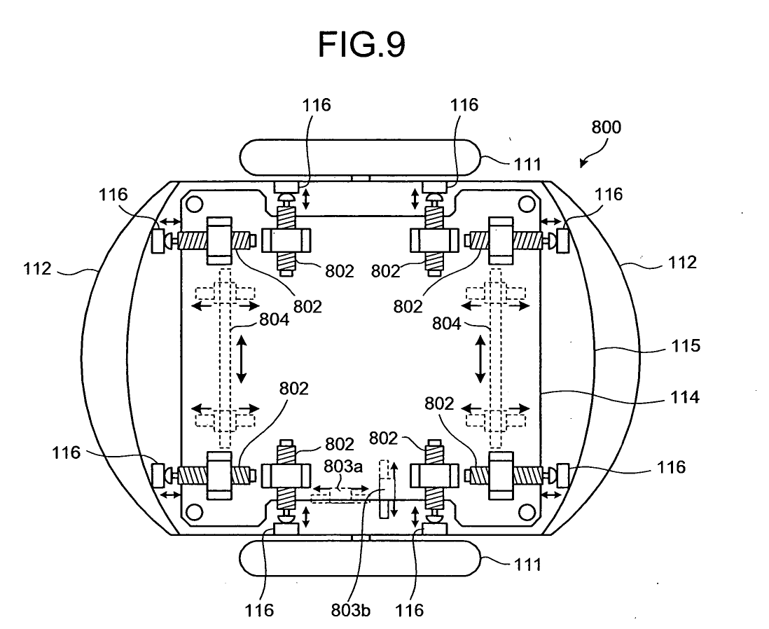

FIG. 9 is a perspective view showing a structure of the continuously connecting portion between the body unit 821 and the movement mechanism unit 822, as viewed from the top. As shown in FIG. 9, the movable robot 800 is provided with the two perpendicular linear guides 804 and the eight shock absorbers 802.

In the perpendicular linear guide 804, a block is mounted on a lower rail in such a manner as to be movable in a direction under the guidance of the lower rail, and further, an upper rail is mounted on the block. The upper rail can be moved in a direction perpendicular to the direction under the guidance of the lower rail. The lower rail is connected to the movement mechanism base plate 806 while the upper rail is connected to the body base plate 805, so that the body base plate 805 can be moved on the plane parallel to the movement mechanism base plate 806.

The two shock absorbers 802 are attached to each of the sides of the body base plate 805, thereby exhibiting a shock absorbing function when the body base plate 805 is moved on the plane parallel to the movement mechanism base plate 806.

In addition, the movement quantity detector 803a and the movement quantity detector 803b also are secured to the lower surface of the body base plate 805, and therefore, they are moved together with the body base plate 805. As a consequence, the movement quantity detector 803a and the movement quantity detector 803b detect the movement quantities of the body unit 821 in the directions perpendicular to each other with respect to the movement mechanism unit 822.

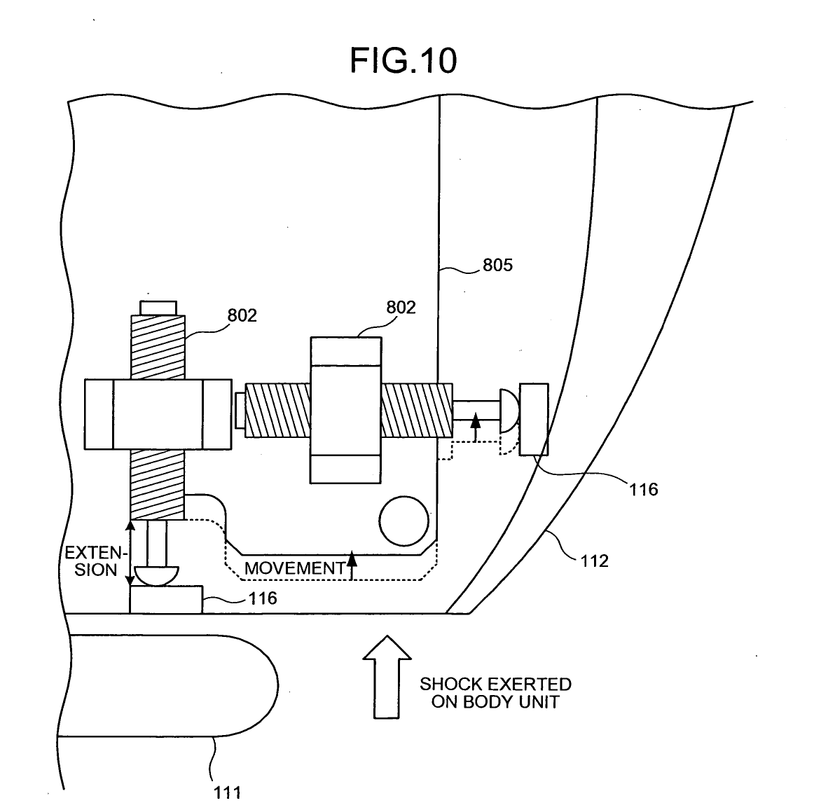

FIG. 10 is a view explanatory of a state in which the body base plate 805 is moved when a shock is exerted sideways on the body unit 821. As shown in FIG. 10, when an external force is exerted sideways on the movable robot 800, the body base plate 805 is moved in a shock exertion direction since the body base plate 805 is connected to the perpendicular linear guides 804. As to the shock absorber 802 provided on a line parallel to the shock exertion direction, the piston rod is depressed down, not shown, in the shock absorber 802 provided at the movement destination of the body base plate 805: in contrast, the piston rod extends in the shock absorber 802 disposed opposite to the above shock absorber 802. To the contrary, as to the shock absorber 802 provided on a line perpendicular to the shock exertion direction, the tip of the piston rod is formed into the semispherical shape, and therefore, slides on the support plate 116. As a consequence, the shock absorber 802 can be moved together with the body base plate 805. With the above-described configuration, the body unit 821 can be moved on the plane parallel to the movement mechanism base plate 806 irrespectively of the interposition of the shock absorbers 802 between the body unit 821 and the movement mechanism unit 822.

As described above, the movable robot in the second embodiment can produce the same effects as those produced by the movable robot 100 in the first embodiment, and further, the body unit 821 can be moved in the direction perpendicular to the straight advance direction with respect to the movement mechanism unit 822. Additionally, the external force can be absorbed, so that the safeness can be enhanced even in the case of the contact against the obstruction.

Although the body unit has been moved in the direction parallel to the movement mechanism base plate in the movable robots in the first and second embodiments, the body unit may be moved independently of the movement mechanism unit, and further, the force may be absorbed during the movement. In view of this, a body unit and a movement mechanism unit are continuously connected to each other via a pivot shaft in place of the linear guide and the perpendicular linear guide in a movable robot in a third embodiment.

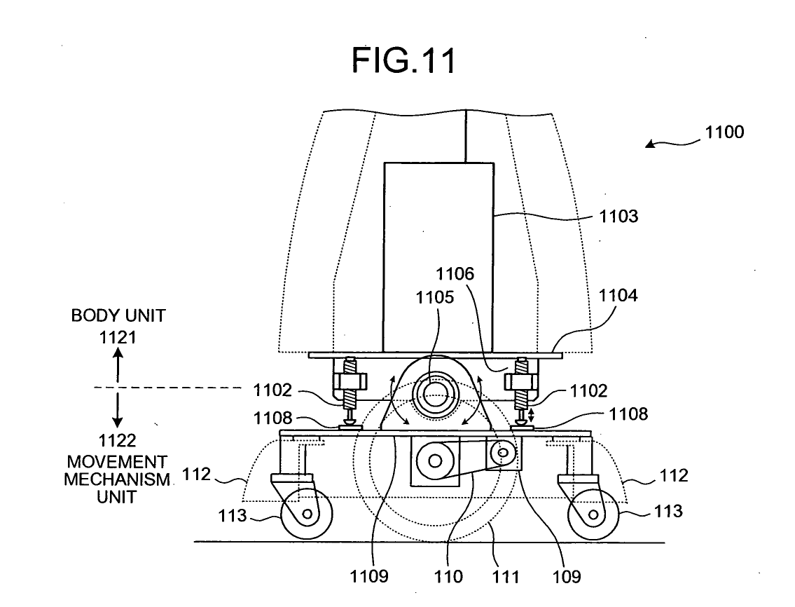

FIG. 11 is a perspective view showing a continuously connecting portion between a body unit 1121 and a movement mechanism unit 1122 in a movable robot 1100, as viewed sideways, in the third embodiment. The same constituent elements as those in the above-described first embodiment will be designated by the same reference numerals, and therefore, the description will be omitted below.

Since the body unit 1121 and the movement mechanism unit 1122 are continuously connected to each other via a pivot shaft 1105, the body unit 1121 can be oscillated independently of the movement mechanism unit 1122.

The body unit 1121 is different from the body unit 121 in the first embodiment in including a control unit 1103 which performs different processing, shock absorbers 1102 which absorb a shock in directions different from each other, a body base plate 1104, supports 1106 on the side of the body unit and a swing quantity detector 1201. Here, the swing quantity detector 1201 is not viewed sideways, and therefore, it will be described later.

The control unit 1103 determines a situation based on signals output from a visual module 101 and the swing quantity detector 1201, described later, and then, outputs a signal instructing an appropriate control to a head controller 102, an arm controller 103 and a drive controller 109.

Moreover, the control unit 1103 determines that the movable robot 1100 collides against an obstruction if it detects a swing quantity of a predetermined value or greater. In the present embodiment, the predetermined value is set at 5°. Therefore, if the control unit 1103 detects a swing quantity of 5° or greater during movement, it determines that the movable robot 1100 collides against the obstruction, and as a consequence, it outputs a signal instructing the control of stoppage of driving to the drive controller 109.

The body base plate 1104 is a base plate for the body unit 1121. To the lower surface of the body base plate 1104 are fixed to the supports 1106 on the side of the body unit. Furthermore, to the support 1106 on the side of the body unit is secured the shock absorber 1102, described later, for supporting the pivot shaft 1105. There is provided, for example, a ball bearing between the support 1106 on the side of the body unit and the pivot shaft 1105, which is thus continuously connected to the support 1106. Additionally, to the lower surface of the body base plate 1104 is fixed the swing quantity detector 1201.

The shock absorber 1102 is fixed to the support 1106 on the side of the body unit, described later, wherein the tip of a piston rod extends toward a support plate 1108 in the movement mechanism unit 1122. As a consequence, the piston rod of the shock absorber 1102 is contracted when the body unit 1121 swings, thereby absorbing an inertial force or an external force generated by a movement control. The four shock absorbers 1102 in total are disposed in the support 1106 on the side of the body unit. In addition, the tip of the piston rod in the shock absorber 1102 is formed into a semispherical shape, thereby reducing friction between the shock absorber 1102 and the support plate 1108. Incidentally, the shock absorber 1102 has the same structure as that of the shock absorber 802 in the second embodiment, and therefore, its description will be omitted below.

The movement mechanism unit 1122 is different from the movement mechanism unit 122 in the first embodiment in including a support 1101 on a side of the movement mechanism unit, the support plates 1108 and a movement mechanism base plate 1109. The support plates 1108 are attached onto the movement mechanism base plate 1109, for supporting the tips of the piston rods in the shock absorbers 1102.

The support 1101 on the side of the movement mechanism unit is adapted to support and fix the pivot shaft 1105 thereby and thereto, so as to prevent any oscillation with respect to the movement mechanism unit 1122. Consequently, the swing quantity detector 1201 provided in the body unit 1121 can detect the swing quantity of the body unit 1121 with respect to the movement mechanism unit 1122. Moreover, the support 1101 on the side of the movement mechanism unit is secured onto the movement mechanism base plate 1109.

In the movable robot 1100 such configured as described above, the body unit 1121 can be oscillated independently of the movement mechanism unit 1122, and further, the shock absorbers 1102 are disposed in the body unit 1121 and the movement mechanism unit 1122, thus absorbing the inertial force generated by abrupt start or abrupt acceleration or the external force exerted on the body unit 1121.

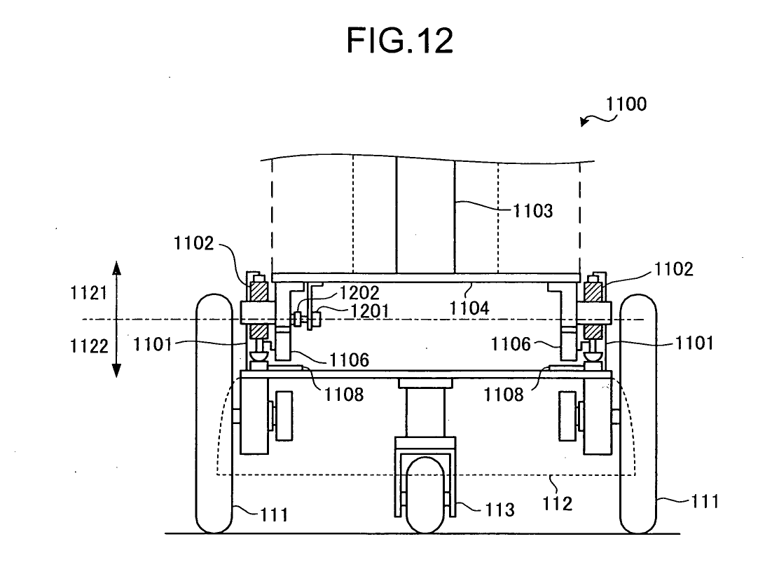

FIG. 12 is a perspective view showing the continuously connecting portion between the body unit 1121 and the movement mechanism unit 1122 in the movable robot 1100, as viewed from the front, in the third embodiment. The same constituent elements as those in the above-described first embodiment will be designated by the same reference numerals, and therefore, the description will be omitted below.

The pivot shaft 1105 is fixed to a shaft of the swing quantity detector 1201, which detects the swing quantity, via a coupling 1202. Since the main body of the swing quantity detector 1201 is secured to the body base plate 1104, the swing quantity detector 1201 can detect the swing quantity.

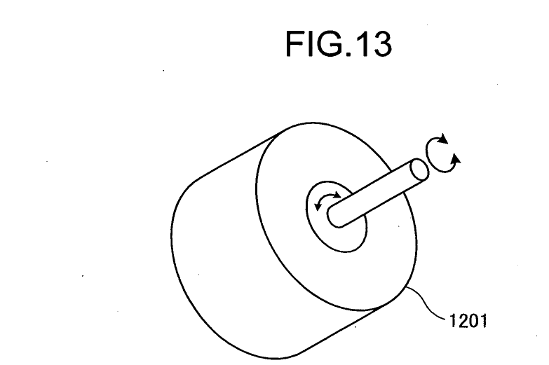

FIG. 13 is a view showing an external appearance of the swing quantity detector 1201. As shown in FIG. 13, the main body of the swing quantity detector 1201 can be oscillated independently of the shaft, so that the swing quantity can be detected by fixing the main body to the body unit 1121 while the shaft to the pivot shaft 1105 secured to the movement mechanism unit 1122. Incidentally, although a pulse meter having the above-described structure has been used as the swing quantity detector 1201 in the third embodiment, a volume or the like consisting of a variable resistance may be used as the swing quantity detector 1201.

Although the swing quantity as a criterion for the judgment of the collision against the obstruction has been set at 5° in the third embodiment, as described above, the predetermined oscillation quantity is not limited to 5°. In actual, an optimum oscillation quantity is set in consideration of the maximum resistance of the shock absorber or the weight of the movable robot.

Furthermore, the same effects as those produced in the first embodiment can be produced in the third embodiment even if the body unit does not slide but swings with respect to the movement mechanism unit, unlike in the movable robot 100 in the first embodiment.

Although the movable robot 1100 can swing in the straight advance direction by the pivot shaft 1105 in the movable robot 1100 in the third embodiment, the swing direction is not limited to the straight advance direction. In view of this, a body unit and a movement mechanism unit are continuously connected to each other via orthogonal pivot shafts in a movable robot in a fourth embodiment.

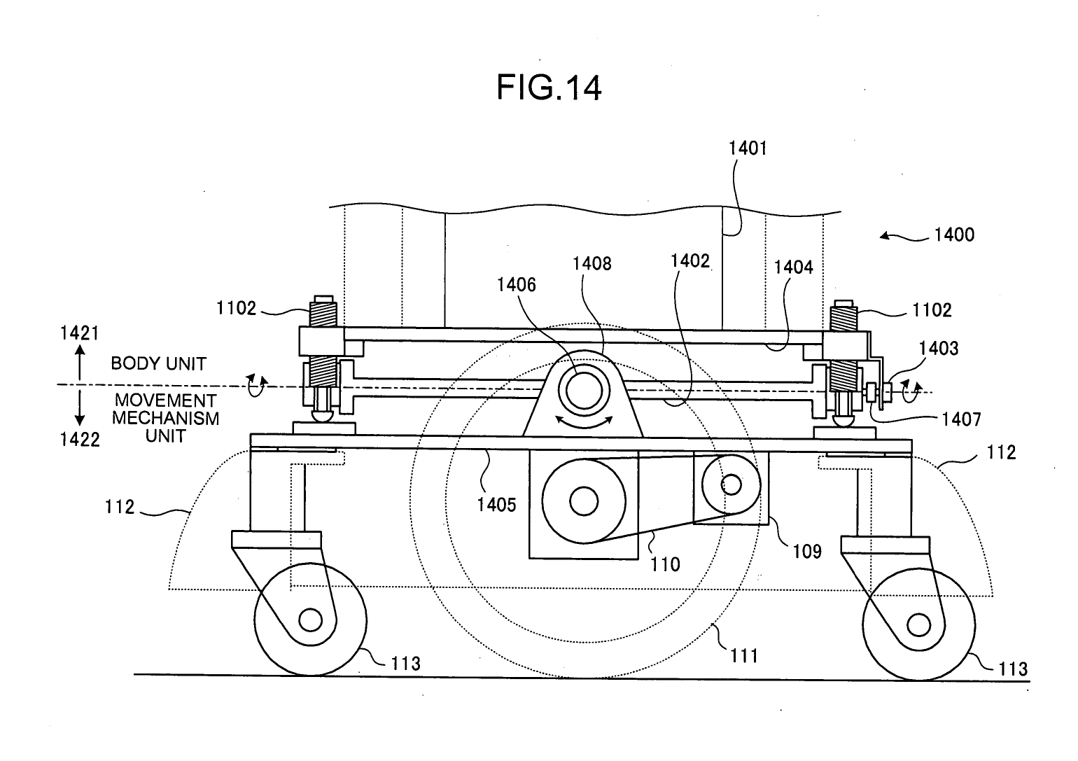

FIG. 14 is a perspective view showing a continuously connecting portion between a body unit 1421 and a movement mechanism unit 1422 in a movable robot 1400, as viewed sideways, in the fourth embodiment. The same constituent elements as those in the above-described third embodiment will be designated by the same reference numerals, and therefore, the description will be omitted below.

Since the body unit 1421 and the movement mechanism unit 1422 are continuously connected to each other via an intermediate rotation support plate 1402 having pivot shafts 1406, the body unit 1421 can be oscillated independently of the movement mechanism unit 1422. Here, the detailed description of the intermediate rotation support plate 1402 will be given below later.

The body unit 1421 is different from the body unit 1121 in the third embodiment in including a control unit 1401 which performs different processing, a body base plate 1404, a pivot shaft support 1501 on a side of the body unit and a swing quantity detector 1403. Here, the pivot shaft support 1501 on the side of the body unit is not viewed sideways, and therefore, it will be described later.

The control unit 1401 determines a situation based on signals output from a visual module 101 and the swing quantity detector 1403 and another oscillation quantity detector 1502, described later, and then, outputs signals instructing an appropriate control to a head controller 102, an arm controller 103 and a drive controller 109. Here, if either one of the swing quantity detector 1403 and the swing quantity detector 1502 detects a swing quantity of 5° or greater during movement, the control unit 1401 determines that the movable robot 1400 collides against an obstruction, and as a consequence, it outputs a signal instructing the control of stoppage of driving to the drive controller 109.

The body base plate 1404 is a base plate for the body unit 1421. At the four corners of the body base plate 1404 are fixed shock absorbers 1102, and further, to the lower surface of the body base plate 1404 is secured the pivot shaft support 1501 on the side of the body unit. There is provided, for example, a ball bearing between the pivot shaft support 1501 on the side of the body unit and the pivot shaft 1406, which is thus continuously connected to the pivot shaft support 1501. Additionally, to the lower surface of the body base plate 1404 is fixed the swing quantity detector 1403.

The swing quantity detector 1403 is fixed to the lower surface of the body base plate 1404, and further, a shaft provided at the swing quantity detector 1403 is secured to the pivot shaft 1406 via a coupling 1407. As a consequence, it is possible to detect the swing quantity of the body base plate 1404 with respect to the intermediate rotation support plate 1402 in a direction perpendicular to a direction, in which the movable robot 1400 can advance straight, that is, the swing quantity of the body base plate 1404 with respect to a movement mechanism base plate 1405 in a direction perpendicular to a straight advance direction. Here, the structure of the swing quantity detector 1403 is the same as that of the swing quantity detector 1201 in the third embodiment, and therefore, its description will be omitted below. Incidentally, the detected oscillation quantity is output to the coupling 1407 (wherein a route is not shown).

The movement mechanism unit 1422 is different from the movement mechanism unit 1122 in the third embodiment in additionally including the movement mechanism base plate 1405, supports 1408 on the side of the movement mechanism unit and the swing quantity detector 1502. Here, the swing quantity detector 1502 is not viewed sideways, and therefore, it will be described later.

The supports 1408 on the side of the movement mechanism unit are secured onto the movement mechanism base plate 1405. A bearing is held between the pivot shaft 1406 and the support 1408 on the side of the movement mechanism unit, so that the support 1408 on the side of the movement mechanism unit can pivotably support the intermediate rotation support plate 1402.

In the movable robot 1400 such configured as described above, the body unit 1421 can be oscillated independently of the movement mechanism unit 1422 in the orthogonal directions, and further, the shock absorbers 1102 are disposed in the body unit 1421 and the movement mechanism unit 1422, thus absorbing an inertial force generated by abrupt start or abrupt acceleration or an external force exerted on the body unit 1421. In particular, the movable robot 1400 can absorb the external force not only in the movement direction but also in the sideways direction.

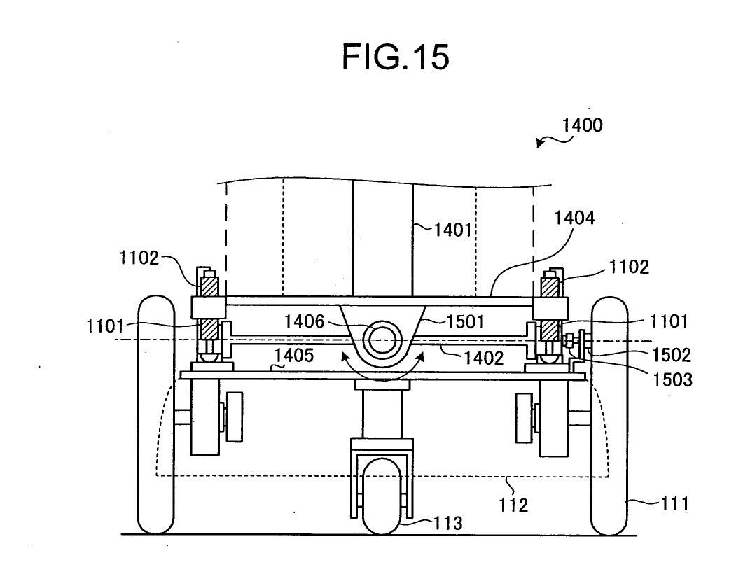

FIG. 15 is a perspective view showing the continuously connecting portion between the body unit 1421 and the movement mechanism unit 1422 in the movable robot 1400, as viewed from the front, in the fourth embodiment.

The pivot shaft support 1501 on the side of the body unit is fixed at the lower surface of the body base plate 1404. A bearing is held between the pivot shaft support 1501 on the side of the body unit and the pivot shaft 1406, so that the pivot shaft support 1501 on the side of the body unit can oscillatably support the intermediate rotation support plate 1402.

The swing quantity detector 1502 is fixed onto the movement mechanism base plate 1405, and further, a shaft provided at the swing quantity detector 1502 is connected to the pivot shaft 1406 provided at the intermediate rotation support plate 1402 via a coupling 1503. As a consequence, it is possible to detect the swing quantity of the movement mechanism base plate 1405 with respect to the intermediate rotation support plate 1402 in a direction, in which the movable robot 1400 can advance straight, that is, the swing quantity of the movement mechanism base plate 1405 with respect to the body base plate 1404 in the straight advance direction. Here, the structure of the swing quantity detector 1403 is the same as that of the swing quantity detector 1201 in the third embodiment, and therefore, its description will be omitted below. Incidentally, the detected oscillation quantity is output to the control unit 1401 (wherein a route is not shown).

The swing quantity of the body unit 1421 with respect to the movement mechanism unit 1422 can be detected in the orthogonal directions by providing the swing quantity detector 1403 and the swing quantity detector 1502.

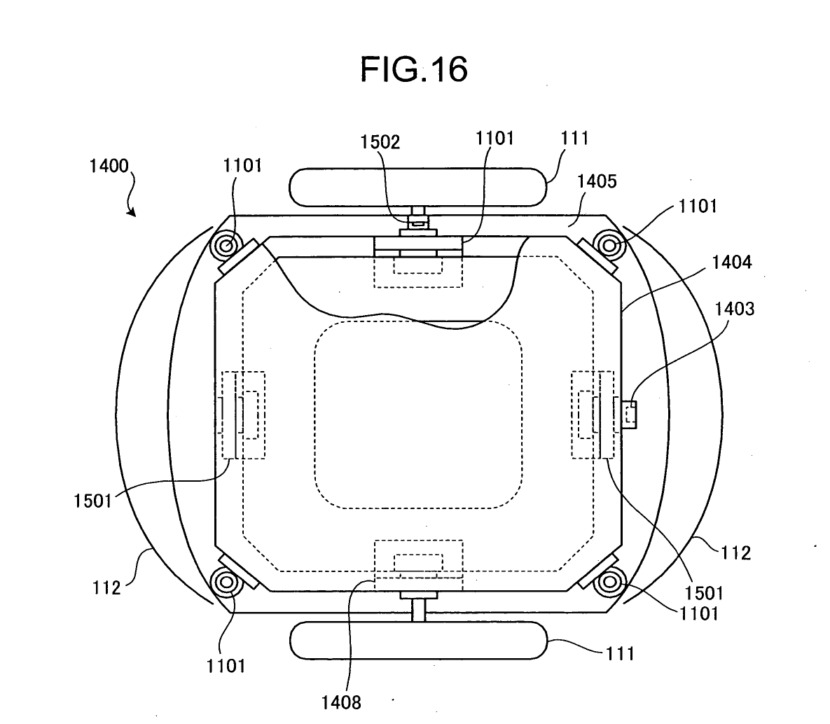

FIG. 16 is a perspective view showing a structure of the continuously connecting portion between the body unit 1421 and the movement mechanism unit 1422, as viewed from the top. As shown in FIG. 16, there are provided four pivot shafts 1406. One oscillation shaft 1406 projects from each of four sides of the intermediate rotation support plate 1402. The two pivot shafts 1406 disposed opposite to each other are secured to the body base plate 1404 via the pivot shaft supports 1501 on the side of the body unit: in contrast, the other two pivot shafts 1406 disposed opposite to each other are secured to the movement mechanism base plate 1405 via the supports 1408 on the side of the movement mechanism unit.

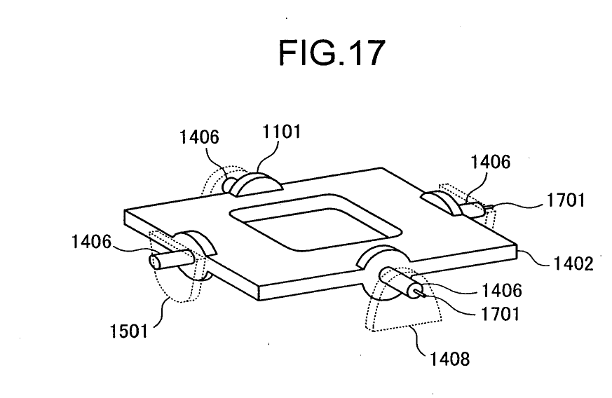

FIG. 17 is a general view showing a shape of the intermediate rotation support plate 1402. As shown in FIG. 17, the intermediate rotation support plate 1402 is provided with the four pivot shafts 1406, two of which are provided with oscillation detecting pins 1701 capable of achieving the connection to the swing quantity detector 1403 and the swing quantity detector 1502, respectively. Furthermore, the intermediate rotation support plate 1402 has a hollow plate portion, and therefore, is reduced in weight.

As described above, the same effects as those produced in the second embodiment can be produced in the fourth embodiment even if the body unit does not slide but swings with respect to the movement mechanism unit, unlike in the movable robot 800 in the second embodiment.

The present invention is not limited to the above-described embodiments, and therefore, various modifications, as shown below, can be carried out.

Although the movable robot has included the two wheels sideways and one auxiliary wheel forward and rearward, respectively, in the above-described embodiments, the present invention is not limited to this. In view of this, a movable robot 1800 in a first modification includes two wheels 1801 and one auxiliary wheel 1802.

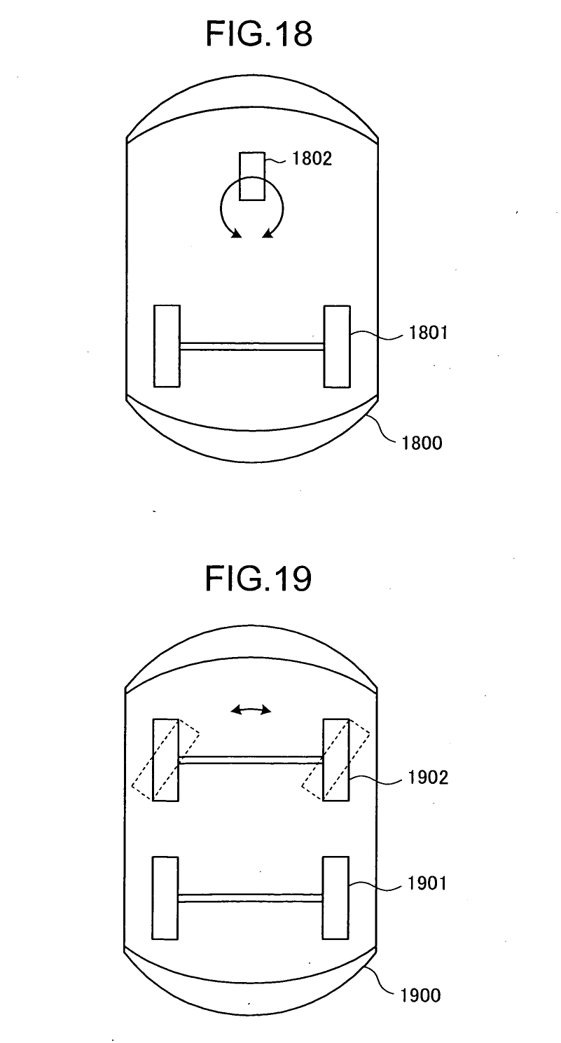

FIG. 18 is a view showing the arrangement of the wheels 1801 and the auxiliary wheel 1802 provided in the movable robot 1800 in the first modification. As shown in FIG. 18, the movable robot 1800 can be moved on a movement plane by the two wheels 1801 and one auxiliary wheel 1802. Moreover, the movable robot 1800 can turn the orientation by controlling the turn of the auxiliary wheel 1802 in a control unit. Additionally, the wheels 1801 are connected to a drive controller, so that the movable robot 1800 can be moved owing to the transmission of driving.

In addition, in a second modification, a movable robot 1900 includes four wheels. FIG. 19 is a view showing the arrangement of the wheels provided in the movable robot 1900 in the second modification. As shown in FIG. 19, the movable robot 1900 can turn the orientation by turning two front wheels 1902 in a direction indicated by a double-headed arrow. Rear wheels 1901 are connected to a drive controller, so that the movable robot 1900 can be moved owing to the transmission of driving.

As described above, the movable robot according to the present invention is featured by the useful technique for preventing any falling over at the time of the abrupt start or the abrupt stoppage even if the center of gravity is located at the high position.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A movable robot comprising:
a movement mechanism unit configured to perform driving for moving the movable robot;
a body unit continuously connected to the movement mechanism unit in a movable manner in a planar direction between the movement mechanism unit and the body unit; and
a shock absorber interposed between the movement mechanism unit and the body unit, for absorbing one of an inertial force and an external force generated by a movement control in the planar direction.

2. The movable robot according to claim 1, further comprising two guides continuously connecting the movement mechanism unit and the body unit and placed in the planer direction, for guiding movement in two orthogonal directions,
wherein the shock absorber includes two absorbers disposed in the respective orthogonal directions between the movement mechanism unit and the body unit, for absorbing one of the inertial force and the external force generated by the movement control in the planar direction.

3. The movable robot according to claim 1, further comprising:
a movement quantity detector that detects a movement quantity of the body unit with respect to the movement mechanism unit in the planar direction; and
a drive controller that controls the driving of the movement mechanism unit when a movement quantity of a predetermined value or more is detected.

4. The movable robot according to claim 3, wherein the drive controller controls the stoppage of the driving of the movement mechanism unit when the movement quantity of the predetermined value or more is detected during the movement by the movement mechanism unit.

5. The movable robot according to claim 3, wherein the drive controller controls the driving of the movement mechanism unit, for achieving the movement in a direction in which the movement quantity is detected when the movement quantity of the predetermined value or more is detected during the stoppage of the movement by the movement mechanism unit.

6. The movable robot according to claim 1, further comprising:
an arm connected to the body unit; and
an arm controller that controls the arm against one of the inertial force and the external force generated by the movement control in the planar direction to keep balance.

7. The movable robot according to claim 1, wherein the shock absorber includes a piston rod having an orifice structure inside thereof to hydraulically absorb the force.

8. The movable robot according to claim 1, further comprising a bumper that absorbs the external force generated when the movable robot collides against an obstruction in the movement direction of the movement mechanism unit.

9. A movable robot comprising:
a movement mechanism unit configured to perform driving for moving a movable robot;
a body unit continuously connected to the movement mechanism unit via a pivot shaft on a plane between the movement mechanism unit and the body unit; and
a shock absorber interposed between the movement mechanism unit and the body unit, for absorbing one of an inertial force and an external force generated by a movement control in swing directions by the pivot shaft.

10. The movable robot according to claim 9, further comprising an intermediate rotation support that continuously connects the movement mechanism unit and the body unit, and has two pivot shafts in two orthogonal directions on the plane,
wherein the shock absorber includes two absorbers interposed between the movement mechanism unit and the body unit, for absorbing one of the inertial force and the external force generated in the swing directions by the pivot shafts disposed in the orthogonal directions.

11. The movable robot according to claim 9, further comprising:
a swing quantity detector that detects a swing quantity of each of the pivot shafts between the movement mechanism unit and the body unit; and
a drive controller that controls the driving of the movement mechanism unit when the swing quantity of a predetermined value or more is detected.

12. The movable robot according to claim 11, wherein the drive controller controls the stoppage of the driving of the movement mechanism unit when the movement quantity of the predetermined value or more is detected during the movement by the movement mechanism unit.

13. The movable robot according to claim 11, wherein the drive controller controls the driving of the movement mechanism unit, for achieving the movement in a direction in which the movement quantity is detected when the movement quantity of the predetermined value or more is detected during the stoppage of the movement by the movement mechanism unit.

14. The movable robot according to claim 9, further comprising:
an arm connected to the body unit; and
an arm controller that controls the arm against one of the inertial force and the external force generated by the movement control in the planar direction to keep balance.

15. The movable robot according to claim 9, wherein the shock absorber includes a piston rod having an orifice structure inside thereof to hydraulically absorb the force.

16. The movable robot according to claim 9, further comprising a bumper that absorbs the external force generated when the movable robot collides against an obstruction in the movement direction of the movement mechanism unit.
